(19) United States
(12) Patent Application Publication
(10) Pub. No.: US 2008/0038687 A1
(43) Pub. Date: Feb. 14, 2008

(54) Articulating Foil Comprising a Coupling Agent

(76) Inventors: Werner Mannschedel, Langenau (DE); Barbara Muller, Langenau (DE)

Correspondence Address: KATTEN MUCHIN ROSENMAN LLP, 575 MADISON AVENUE, NEW YORK, NY, 10022-2585, US

(21) Appl. No.: 10/587,491

(22) PCT Filed: Jan. 31, 2005
(86) PCT No.: PCT/EP05/00921

§ 371 Date: Apr. 4, 2007

(30) Foreign Application Priority Data
Jan. 29, 2004 (DE) 10-2004-004-559.3

(51) Int. Cl. A61C 9/00

(52) U.S. Cl. 433/70

(57) ABSTRACT

The present invention relates to an articulating paper for use in dentistry, which comprises a support layer that is provided on at least one side with at least one colour layer comprising a colouring pigment, wherein there is present, on at least one colour layer, a layer that has at least one adhesion promoter for the colouring pigment(s) of the colour layer(s).

The present invention relates to the field of dentistry aids and relates to an articulating aid, referred to hereinafter as articulating paper, for marking contact sites of teeth of a masticatory unit/occlusal unit.

In dentistry, the “masticatory unit” denotes the teeth of the upper and lower rows of teeth brought into engagement with one another when biting together. As distinct from that, the “occlusal unit” indicates the teeth of the upper and lower rows of teeth brought into engagement with one another in the case of relaxed closure of the jaw. In both cases, the teeth of the upper and lower rows are brought into contact with one another only at individual contact sites, that is to say not over their entire surface.

In dentistry, teeth damaged by caries are usually provided with fillings made of gold, ceramics, amalgam or synthetic material. Where a tooth is damaged to such an extent that a filling can no longer be used, in more extensive prosthetic measures so-called onlays, partial crowns or full crowns are applied to the tooth.

In such restorative dental treatment, it is important for the teeth to have a suitable bite again following treatment, that is to say it must be possible for the teeth of the upper and lower rows to be so pressed against one another by relaxed closure of the jaw or by muscular force that a bite of that kind is not adversely affected by individual contact sites that are “too high”, which may lead to muscular tension and other adverse health effects. In other words, the contact sites of a masticatory unit/occlusal unit should adjoin one another with a substantially equal pressure load. In the present invention, the “height” of a contact site denotes the distance of a contact site from the tooth apex in apical-basal direction.

The dentist is therefore faced with the problem that the bite generally needs to be realigned following a restorative treatment of teeth. In order to align the bite, the dentist uses thin, pliable articulating papers which, in a conventional arrangement thereof, consist of a support layer of plastics material with a colour layer applied thereto. The colour layer is usually a colour wax, such as, for example, vegetable carnauba wax, that comprises colouring pigments.

In practical use, those articulating papers are inserted between the teeth of the masticatory unit/occlusal unit containing the treated tooth and the patient is asked to make chewing movements. During the chewing movement, the colouring pigments of the colour layer of the articulating paper are rubbed off by the contact sites, so that the dentist is able, from the resulting colour marks on the tooth, to identify where the contact sites of the teeth of a masticatory unit/occlusal unit are located. If the contact sites are too high, that is to say when they prevent a suitable bite of the masticatory unit/occlusal unit, those contact sites are ground down to a suitable height or until the patient finally signals his agreement that the bite is comfortable.

A disadvantage in that is that the colouring pigments of the colour layer adhere to different materials only with varying success. It is thus known to the skilled person that the colouring pigments adhere comparatively well to dentine but have poor adhesion to gold and ceramics. The result is a poor capacity to colour fillings, onlays, partial crowns and the like consisting of gold or ceramics.

The problem underlying the present invention is accordingly to overcome that disadvantage associated with the articulating papers known in the prior art.

That problem is solved in accordance with the invention by an articulating aid such as an articulating paper, (referred to hereinafter as articulating paper), that corresponds to the features of the main claim. Advantageous developments of the invention are indicated in the sub-claims.

According to the proposal of the invention, in the articulating paper, which is provided on at least one side with at least one colour layer containing at least one colouring pigment, there is for that purpose present, at least on one colour layer, a layer that comprises at least one adhesion promoter for the colouring pigment(s) of the colour layer(s). By means of such an adhesion promoter present in the adhesion promoter layer, the adhesion of the colouring pigment(s) of the colour layer(s) to materials used in dental treatment, such as gold, ceramics, synthetic material or amalgam, is improved. In other words, the materials used in dental treatment can more readily be coloured using the articulating paper according to the invention by the use of an adhesion promoter, so that the contact sites of a masticatory unit/occlusal unit can be marked in a more secure and more reliable manner. The adhesion promoter in such an arrangement acts especially in the manner of an adhesive, which imparts a force-based surface union between the colouring pigment(s) of at least one of the colour layer(s) and the materials used in the dental treatment. The adhesion promoter can also be so selected that it improves the adhesion of individual colouring pigments only or of all colouring pigments of the colour layers to the materials used in the dental treatment. Different articulating papers may have different colours and/or adhesion promoters, for example according to the material to be coloured.

The adhesion promoter is brought into contact with the colouring pigments, for example, when the adhesion promoter layer is bitten through during a chewing movement by the contact site of a tooth and the contact site rubs off the colouring pigments of a colour layer. The adhesion promoter may, for example, be incorporated in the adhesion promoter layer in a suspended or dissolved form.

In a preferred development of the invention, the adhesion promoter, which is applied as adhesion promoter layer to a colour layer, is encapsulated in microcapsules. The encapsulation of substances in microcapsules is a technique familiar to the person skilled in the art which does not need to be described in detail herein. For example, such microcapsules contain ester wax and have a size of from 0.1 μm to 1000 μm; preferably, the microcapsules have a size in the range from 2 μm to 30 μm.

In an advantageous development of the microcapsules, the microcapsules are so formed that they release the adhesion promoter only as a result of the action of an activator. Preferably, the adhesion promoter is released by crushing the microcapsules containing the adhesion promoter by biting. This makes it possible for the adhesion promoter to be released only at the contact sites of a masticatory unit/occlusal unit at which a biting action occurs. It is likewise possible, and in accordance with the invention preferred, for the adhesion promoter to be released from the microcapsules only after UV irradiation of the microcapsules, by means of which the release of the adhesion promoter can be restricted to the area of the masticatory unit/occlusal unit. In that manner it is possible for the total amount of adhesion promoter to which the patient is exposed and which, in significant amounts, might possibly have an adverse effect on the health/well-being of the patient, to be kept to a minimum.

In a further advantageous development of the invention, the articulating paper comprises, on one or both sides, a plurality of differently coloured colour layers and at least one adhesion promoter layer applied to one of the colour layers. The plurality of differently coloured colour layers advantageously makes it possible for the relative height of a contact site with respect to the height of that contact site suitable for a bite to be ascertained in simple manner. Where the articulating paper has, for example, two differently coloured colour layers, for example a red first colour layer on the support material and a green second colour layer on the red first colour layer, then the dentist is able to identify, when there are green-coloured and red-coloured contact sites after using the articulating paper, that the red-coloured contact sites have a more intensive bite contact with the corresponding tooth/teeth of the masticatory unit/occlusal unit than the green-coloured contact sites. In other words, any red-coloured contact site is still too high with respect to a height of that contact site suitable for a bite and needs to be ground down to achieve a suitable bite. By repetition of the procedure by the dentist it is possible, by successive grinding down of red-coloured contact sites, for a substantially uniform pressure load between the contact sites of a masticatory unit/occlusal unit to be achieved, that being indicated when only green-coloured contact sites still occur when the articulating paper according to the invention is used.

As an alternative, an articulating paper according to the invention may have a different number of colour layers and/or adhesion promoter layers on both sides, an adhesion promoter layer being applied to a colour layer at least one side. For example, an articulating paper of that kind may have only one colour layer on one side and a plurality of colour layers on the other side, an adhesion promoter layer being present on a colour layer at least on one side.

It is, however, also possible for the articulating paper according to the invention to have only one colour layer on both sides, with adhesion promoter layers being applied to one or both colour layers.

When the articulating paper has a plurality of differently coloured colour layers, either the adhesion promoter layer may be applied to one colour layer only, or a separate adhesion promoter layer may be applied to each of a plurality of colour layers. Where there is a plurality of adhesion promoter layers, the adhesion promoter of one layer may be different from the adhesion promoter of another layer. In addition, an adhesion promoter may be inserted in one or more of the differently coloured colour layers. When the adhesion promoter is inserted in a plurality of colour layers, the adhesion promoter of one layer may be different from the adhesion promoter of another layer in order, for example, suitably to match the adhesion-imparting property to the specific colouring pigments of a colour layer.

In accordance with the invention, it may be advantageous when the colour layers have different layer thicknesses. Thus, where the layer thicknesses of the colour layers diminish from the support material towards the uppermost colour layer, the dentist is able to establish a suitable height of a contact site very precisely. When the articulating paper is provided, for example, with three differently coloured colour layers, such as, for example, a red colour layer on the support layer having a large layer thickness in the range from 1 to 20 μm, a green colour layer on the red colour layer having a medium layer thickness in the range from 1 to 10 μm, and a yellow colour layer on the green colour layer having a small layer thickness in the range from 1 to 10 μm, then coloration of a contact site varies from red to green to yellow as the height increment diminishes.

The colouring pigments used in accordance with the invention are colouring pigments customary per se for articulating aids.

Further, it is especially advantageous when the uppermost colour layer, that is, the colour layer the furthest removed from the support material, defines a tolerance height for contact sites of a masticatory unit/occlusal unit. In other words, when the contact sites of a masticatory unit are uniformly coloured by the uppermost colour layer only, the height of the contact sites of the masticatory unit/occlusal unit lie within a tolerance measurement for a height of the contact sites appropriate for producing a suitable, anatomically acceptable bite. For example the layer thickness of the uppermost colour layer in such an arrangement is from 5 to 10 μm, preferably from 7 to 9 μm, especially 8 μm.

The colour layers of the articulating paper of the present invention may advantageously be coloured wax colour layers. Examples are: vegetable waxes (for example carnauba wax, montan wax), animal waxes (for example beeswax), mineral waxes (for example ceresin), petrochemical waxes (for example paraffin waxes, micro waxes) and chemically modified hard waxes (for example montan ester waxes, jojoba waxes), synthetic waxes (for example polyethylene glycol waxes).

The layer thickness of the colour layers may be dependent, for example, on the material of the colour layer, the layer thickness being from 0.1 to 30 μm, preferably from 1 to 20 μM, especially preferably from 1 to 8 μm.

The adhesion promoter may be, for example, from the group of the natural resins (balsams, colophony, fossil resins), also carbohydrates (starch, dextrin, sugars), proteins (albumin, casein, gelatin), rubber (latex, dried latex, precipitated latex), waxes and other natural substances (beeswax, shellac, gum arabic), or synthetic adhesion promoters (for example methyl cellulose, polyvinyl alcohol, polyvinylpyrrolidone, polystyrene, polyvinyl chloride, polyacrylates, polymethacrylates, polyvinyl acetate, polyvinyl acetate polyethylene mixtures, nitrocellulose, polychloroprenes, rubbers, polyurethanes, methacrylates, cyanoacrylates, diacrylic acid esters, epoxy resins or polyesters.

The adhesion promoter has a tackiness that enables it to impart the force-based surface union between the colouring pigment(s) of the colour layer(s) and the materials used in the dental treatment, such as gold, ceramics, synthetic material or amalgam. The layer thickness of the adhesion-promoter is, for example, from 0.1 to 5 μm, preferably from 2 to 4 μm and, most preferably, 3 μm. Where there is a plurality of adhesion promoter layers, the layer thicknesses of the individual adhesion promoter layers may be different.

The support layer of the articulating paper may consist of, or comprise, for example, polyvinyl chloride, polyethylene, polypropylene, PET or silicone. It is also possible for the support layer to consist of or comprise paper or woven fabrics, knitted fabrics or non-wovens. In the latter case, the pores of the support, especially of paper, are preferably impregnated with the colorant containing the colouring pigment. It is furthermore advantageous when the colour characteristic of the coating of the articulating aid having different adhesion promoters assumes a coding function, (for example yellow for amalgam, blue for composite, green for ceramics, black for gold), in order to simplify for the user identification of the materials that suit one another.

Referring to the accompanying drawing, the invention is explained in greater detail by way of an example embodiment.

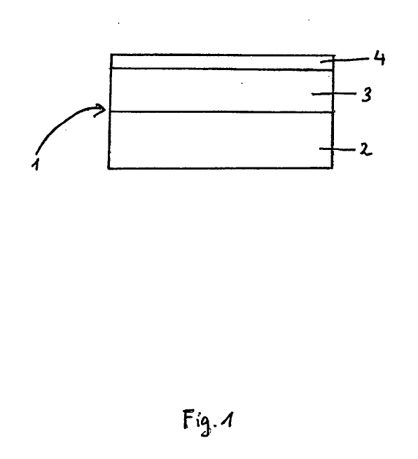

FIG. 1 is a diagrammatic cross-section of an example embodiment of the articulating paper according to the invention.

FIG. 1 is a diagrammatic cross-section of an example embodiment of the articulating paper 1 according to the invention. The articulating paper 1 comprises a support 2 of PVC, to which there is applied a wax colour layer 3 consisting of green-coloured carnauba wax. The thickness of the wax colour layer 3 is 8 μm. Applied to the wax colour layer 3 is a layer 4 which comprises an adhesion promoter. The thickness of the adhesion promoter layer is 3 μm.

1. Articulating paper for use in dentistry, which comprises a support layer that is provided on at least one side with at least one colour layer comprising a colouring pigment, characterised in that there is present, on at least one colour layer, a layer that has at least one adhesion promoter for the colouring pigment(s) of the colour layer(s).

2. Articulating paper according to claim 1, characterised in that an adhesion promoter is present in at least one colour layer.

3. Articulating paper according to claim 1, characterised in that the adhesion promoter is encapsulated in microcapsules.

4. Articulating paper according to claim 3, characterised in that microcapsules are suitable for releasing the adhesion promoter as a result of the action of pressure on the microcapsules.

5. Articulating paper according to claim 3, characterised in that the microcapsules are suitable for releasing the adhesion promoter as a result of the action of an activator.

6. Articulating paper according to claim 5, characterised in that the microcapsules are suitable for releasing the adhesion promoter as a result of UV irradiation of the microcapsules.

7. Articulating paper according to claim 5, characterised in that the microcapsules are suitable for releasing the adhesion promoter as a result of the application of heat to the microcapsules.

8. Articulating paper according to claim 1, characterised in that it has a plurality of differently coloured colour layers.

9. Articulating paper according to claim 8, characterised in that the colour layers have different layer thicknesses.

10. Articulating paper according to claim 8, characterised in that the uppermost colour layer corresponds to a tolerance height for contact sites of a masticatory unit/occlusal unit.

11. Articulating paper according to claim 10, characterised in that the layer thickness of the uppermost colour layer is about 8 μm.

12. Articulating paper according to claim 1, characterised in that the colour layers are coloured wax colour layers.

13. Articulating paper according to claim 1, characterised in that the support layer comprises or consists of paper.
